(19) United States
(12) Patent Application Publication
(10) Pub. No.: US 2016/0104983 A1
(43) Pub. Date: Apr. 14, 2016

(54) ELECTRICAL JUNCTION BOX

(71) Applicant: Yazaki Corporation, Tokyo (JP)

(72) Inventors: Makoto Nakayama, Makinohara-shi (JP); Takahiko Mitsui, Makinohara-shi (JP); Ryo Nakano, Makinohara-shi (JP)

(21) Appl. No.: 14/972,582

(22) Filed: Dec. 17, 2015

Related U.S. Application Data
(63) Continuation of application No. PCT/JP2014/068669, filed on Jul. 14, 2014.

(30) Foreign Application Priority Data
Jul. 16, 2013 (JP) 2013-147498

(51) Int. Cl. H01R 13/74; H02G 3/08

(52) U.S. Cl. CPC H01R 13/74; H02G 3/081

(57) ABSTRACT

The objectives of the present invention is to provide an electrical junction box that can sufficiently prevent the transmission of noises or vibrations emitted from an electrical component disposed inside of the electrical junction box. The electrical junction box includes: a relay having terminals; electrical wires connected to the terminals on the relay; and a casing body made of insulating resin containing the relay. The casing body is formed to have an accommodation portion that surrounds and contains the relay without contacting the same and a lead-out portion by which the electrical wires are led out of the accommodation portion. At least one of the following supporters is provided with: a first supporter for supporting the relay by an inner mold interposed between the relay and the inner face of the accommodation portion of the casing body; and a second supporter for supporting the relay via the electrical wires.

### TECHNICAL FIELD

The present invention relates to electrical junction box mounted on vehicle.

### BACKGROUND ART

The electrical junction box mounted on vehicles typically includes electrical components such as relays, fuses, fusible links or the like, a box body (casing body) made of insulation resin accommodating such electrical components, and external terminals electrically connecting the electrical components and external apparatuses. Further, an affixing portion provided in the box body is affixed on a vehicle panel by bolts. It is likely that when such an electrical junction box accommodates electrical components (i.e., relay) which generate noises or vibrations, the emitted noises or vibrations is transmitted to the vehicle body as solid-borne noises via the box body so as to make passengers feel uncomfortable. Under such a circumstance, the electrical junction box in which noise insulating properties are taken into account has been proposed (refer to PTL 1).

The electrical junction box described in PTL 1 is configured to include a relay, an electrical circuit substrate and an apparatus body (casing body), and the relay is mounted on the electrical circuit substrate via a cushion material by which the transmission of noises or vibrations are prevented.

### CITATION LIST

### Patent Literature

PTL 1: JP 2000-164097 A

### SUMMARY OF INVENTION

### Technical Problem

However, according to the conventional electrical junction box as described in PTL 1, noises or vibrations of the relays are transmitted to the electrical circuit substrate via bus bars which electrically connect the relay terminals and the electrical circuit substrates, and since the electrical circuit substrates are affixed to the apparatus body (casing body) with bolts in a contact condition, such a problem is caused as that the noises or vibrations transmitted to the electrical circuit substrates are directly transmitted to the casing body.

Under such a situation, the present invention aims to provide an electrical junction box which can effectively suppress the transmission of noises or vibrations generated at embedded electrical components.

### Solution to Problem

To attain the above described objectives, the electrical junction box set forth in one aspect of the present invention includes: an electrical component equipped with a terminal; an electrical connection member connected to the terminal of the electrical component; a casing body made of insulation resin and accommodating the electrical components; and at least one of a first supporter supporting the electrical component by a first support member interposed between the electrical component and an inner face of an accommodation portion, and a second supporter supporting the electrical component via the electrical connection member, wherein the casing body is formed to include the accommodation portion which contactlessly accommodates the electrical component in a manner surrounding the electrical component, and a lead-out portion leading the electrical connection member out from the accommodation portion.

The electrical junction box in a first preferred aspect of the present invention is the electrical junction box according to the one aspect of the present invention, wherein the first support member is made of elastic material having vibration-free property and surrounds the electrical component with no gaps therebetween, and the electrical junction box is provided in close contact with the inner face of the accommodation portion, and wherein the first support member is provided with an insertion portion having the electrical connection member insert thereinto.

The electrical junction box in a second preferred aspect of the present invention is the electrical junction box according to the one aspect or the first preferred aspect of the present invention, wherein the second supporter is formed to include a second support member made of elastic material having vibration-free property, the second support member interposed between the electrical connection member and the lead-out portion, and wherein the second support member surrounds the electrical connection member with no gaps therebetween and is provided in close contact with an inner periphery of the lead-out portion.

The electrical junction box in a third preferred aspect of the present invention is the electrical junction box according to any one of the one aspect to the second preferred aspect of the present invention, wherein the accommodation portion is composed of a hole having an opening that opens toward one side, and a cover portion for covering the opening of the hole, and wherein the first support member is configured to include an innermost-side member provided at an innermost-side of the hole and an opening-side member provided at the opening-side of the hole as well as at the cover portion side.

### Advantageous Effects of Invention

According to the invention in the one aspect of the present invention, since the electrical component is supported by at least one of the first supporter supporting the electrical component by the first support member interposed between the electrical component and the inner face of the accommodation portion, and the second supporter supporting the electrical component via the electrical connection member, the electrical component is contactlessly supported with respect to the accommodation portion, and the electrical component is accommodated in the accommodation portion in a manner surrounded by the accommodation portion. Thereby, even when noises or vibrations are generated at the electrical component, the noises or vibrations are prevented from being directly transmitted to the accommodation portion.

According to the invention in the first preferred aspect of the present invention, since the first support member is made of an elastic material having vibration-free property, noises or vibrations transmitted from the electrical component to the inner face of the accommodation portion via the first support member are attenuated. Thereby, noise insulating property and vibration-free property thereof can be further enhanced. Further, since the first support member surrounds the electrical component and the first support member is provided with the inner face of the accommodation portion in close contact thereto, noises generated at the electrical component can be prevented from leaking out. Further, since the insertion portion is formed in the first support member and the electrical connection member is led out through the insertion portion, noises and vibrations leaked out by their propagation on the electrical wire can also be suppressed.

According to the invention recited in the second preferred aspect of the present invention, since the second supporter is configured to include the second support member made of elastic material having vibration-free property, the second support member interposed between the electrical connection member and the lead-out portion, noises or vibrations transmitted from electrical component to the lead-out portion via the electrical connection member and the second support member are attenuated. Thereby, noise insulating property and vibration-free property thereof can further be enhanced. Further, since the second support member surrounds the electrical connection member with no gaps therebetween and the second support member is provided in close contact with the inner periphery of the lead-out portion, noises generated at the electrical component and propagating via the electrical wire can be prevented from leaking out to the outside of the accommodation portion.

According to the invention recited in the third preferred aspect of the present invention, since the accommodation portion is composed of the hole and the cover portion, and the first support member is configured to include the innermost-side member and the opening-side member, that is, first support member is divided into two pieces by the innermost-side and opening-side of the hole. Thereby, the assembly procedures when accommodating the electrical component and the first support member in the accommodation portion can be optimized. Specifically, the innermost-side member is firstly set in the accommodation portion, subsequently, the electrical component are made supported therein. Next, the opening member is set in the accommodation portion in a state where the opening member is in close contact with the innermost-side member and the electrical component. Subsequently, the accommodation portion is closed by the cover portion. Thereby, the electrical component and the first support member can be securely assembled to the accommodation portion.

### BRIEF DESCRIPTION OF THE DRAWINGS

FIG. 1 is a perspective view of the electrical junction box according to the first embodiment of the present invention.

FIG. 2 is an exploded perspective view of the electrical junction box.

FIG. 3 is a perspective view of the electrical component accommodated in the casing body.

FIG. 4 is an upper facial view of the casing body.

FIG. 5 is a right side facial view of the casing body.

FIG. 6 is a view of a bottom face of the casing body.

FIG. 7 is a sectional view indicated by arrow A line in FIG. 6.

FIG. 8 is a sectional view indicated by arrow B line in FIG. 6.

FIG. 9 is a view explaining assembly procedures of an electrical junction box.

FIG. 10 is a view explaining assembly procedures of an electrical junction box.

FIG. 11 is a view showing a first support member in an electrical junction box according to the second embodiment of the present invention.

### DESCRIPTION OF EMBODIMENTS

### First Embodiment

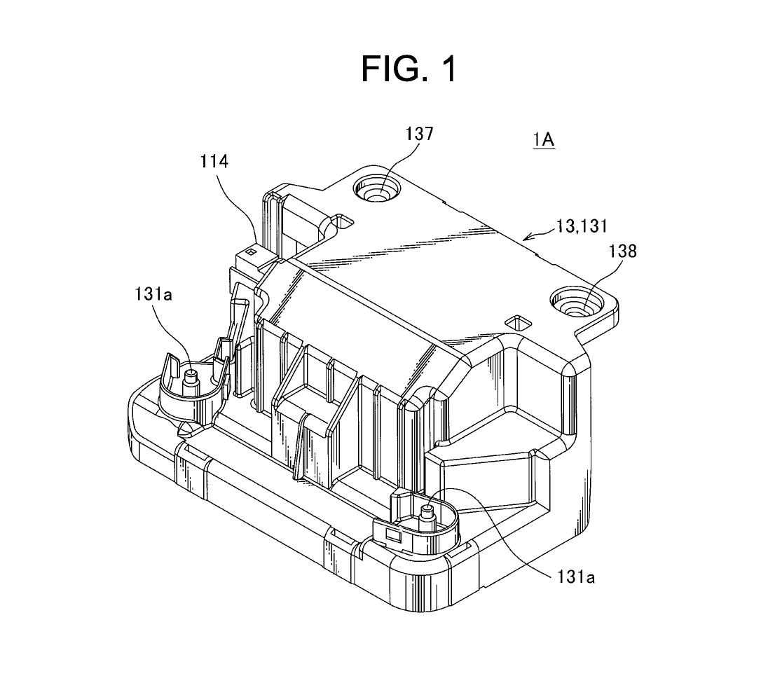

The electrical junction box according to a first embodiment of the present invention is described with reference to FIGS. 1 to 10.

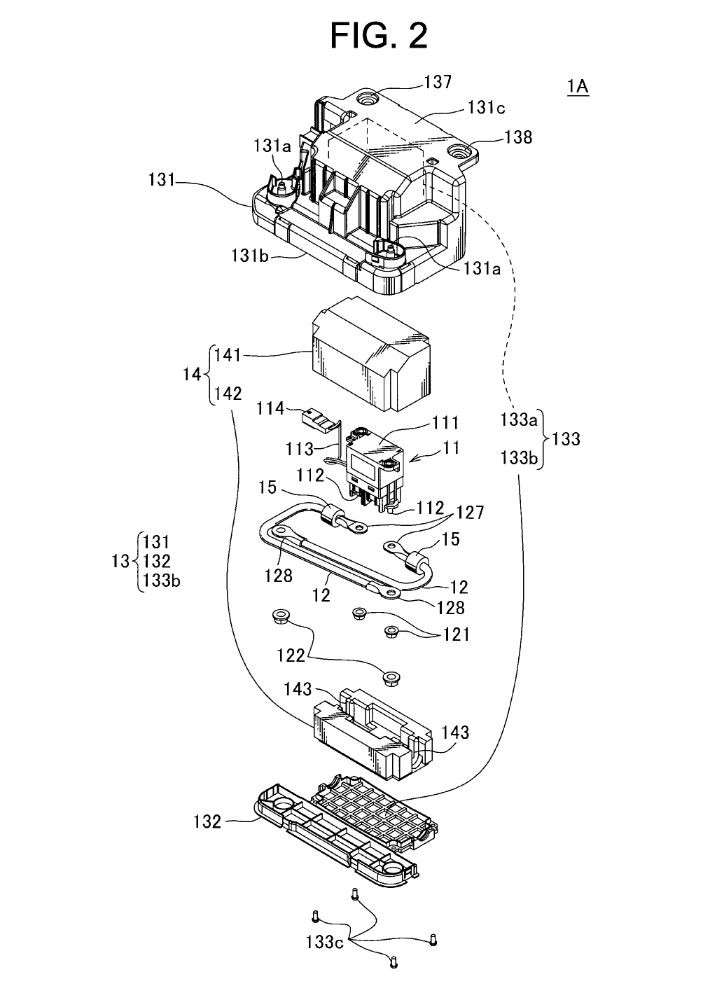

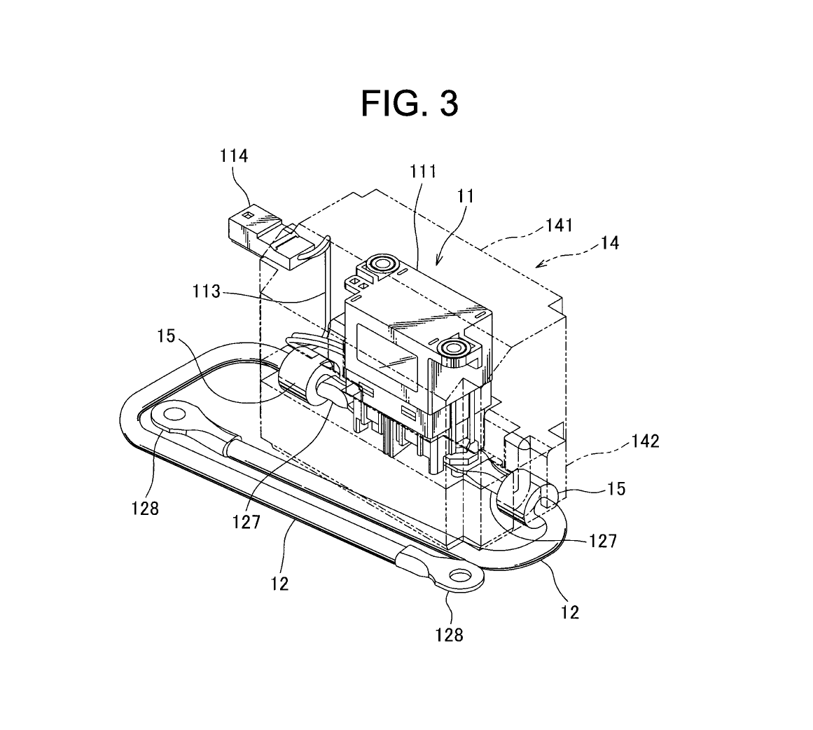

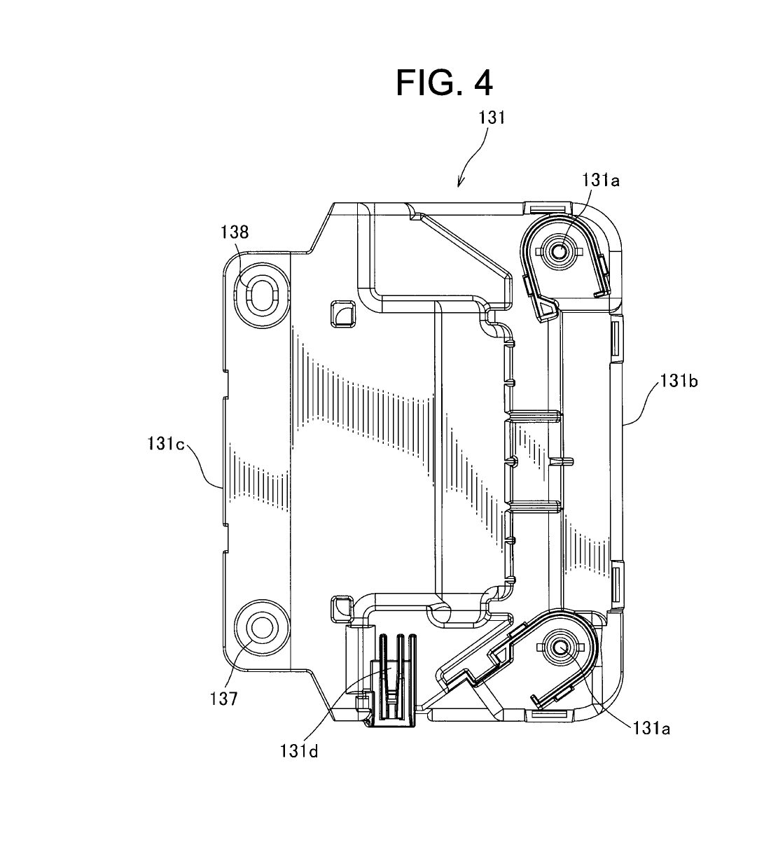

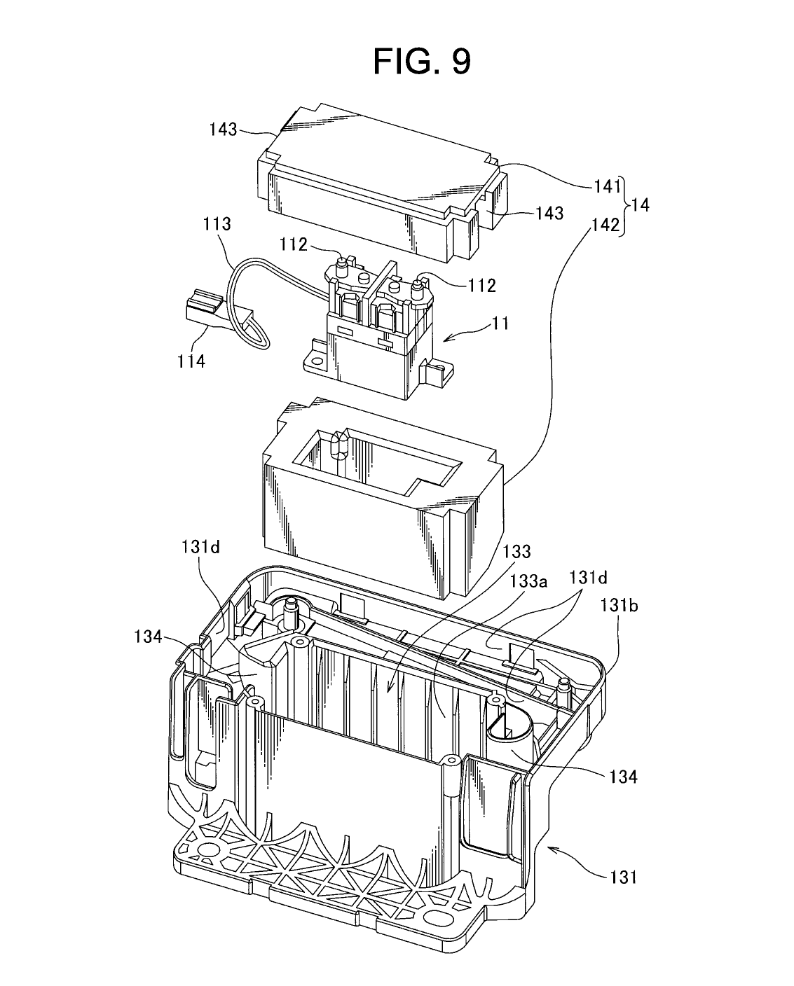

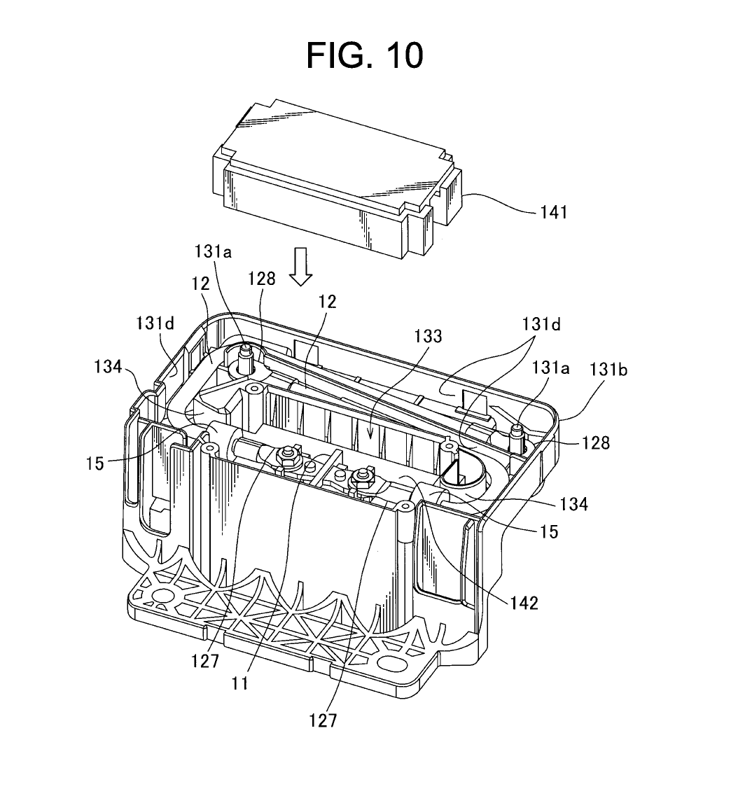

An electrical junction box 1A is mounted, for example, on a vehicle having idling stop function, and in normal driving mode of the vehicle, as for a plurality of large-capacity batteries, the electrical junction box 1A supplies electrical power to many types of electrical components from all of the batteries, while in idling mode of the same, the electrical junction box 1A implements current-applying control by which supplying electrical power from the batteries is stopped, reserving a part of the electrical power for charging. The electrical junction box 1A includes a relay 11 having a large capacity as an electrical component, an electrical wire 12 for electrification connected to a terminal 112 of the relay 11, and a casing body 13 in which the relay 11 is accommodated. FIG. 1 is a perspective view of the electrical junction box 1A, and FIG. 2 is an exploded perspective view of the electrical junction box 1A. Further, FIG. 3 is a perspective view of the relay 11 accommodated in the casing body 13. Further, FIGS. 4-8 are views explaining a casing body 131 constituting the casing body 13, and FIGS. 9 and 10 are views explaining assembly procedures of the electrical junction box 1A.

As shown in FIG. 2, the relay 11 includes a relay body 111, a pair of the terminals 112 to which electrical wire 12 is connected, and a control connector 114 connected to the relay body 111 via a control electrical wire 113. The control connector 114 is, as shown in FIG. 1, exposed to the outside of the electrical junction box 1A in appearance. The control connector 114 is connected to a connector of an external control electrical wire which is not shown. Then, control signals are transmitted to the relay 11 via the control connector 114, the control electrical wire 113, and the external control electrical wire so as to open and close the inner contact of the relay 11, and opening and closing operations of the inner contact of the relay 11 are performed in response to the control signal.

In the electrical wire 12, first end round terminals 127 are connected to the terminals 112 of the relay 11 by nuts 121, and second end round terminals 128 are connected to external connection terminals 131a by nuts 122. The electrical junction box 1A is provided with a pair of the electrical wires 12.

The casing body 13 is configured with the casing body 131 made of synthetic resin, a cover member 132 made of synthetic resin partially covering the lower end portion of the casing body 131 and affixed to the casing body 131 by engagement of engaging claws, and a cover portion 133b covering a hole 133a that opens to a remaining part of the lower end portion of the casing body 131 and affixed to the casing body 131 by screws 133c. The hole 133a will be described later. The casing body 13 is formed to include an accommodation portion 133 which contactlessly accommodates the relay 11 in a manner surrounding the relay 11, and lead-out portions 134 through which electrical wires 12 are led out from the accommodation portion 133.

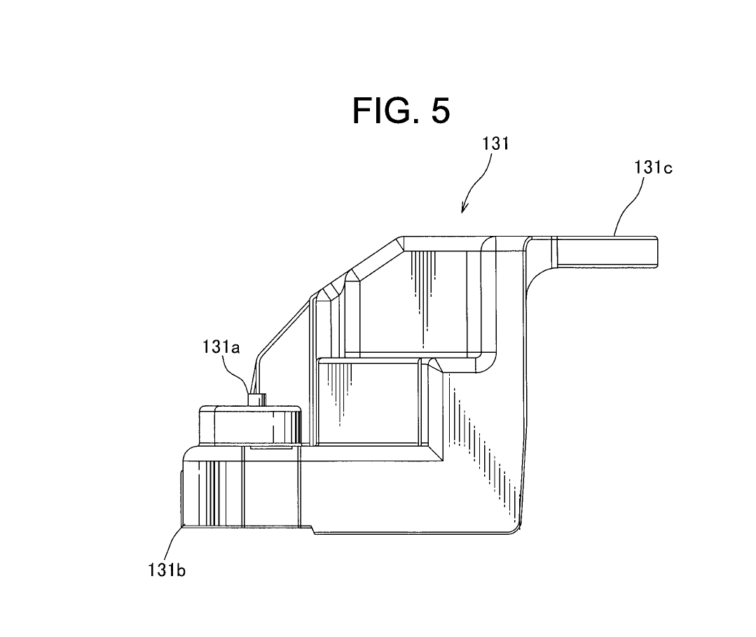

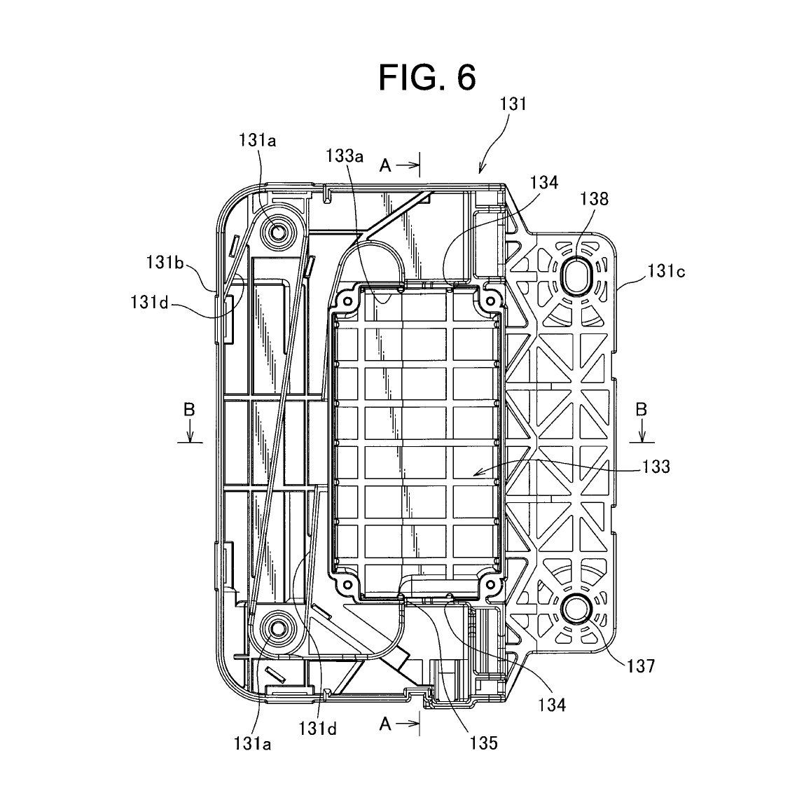

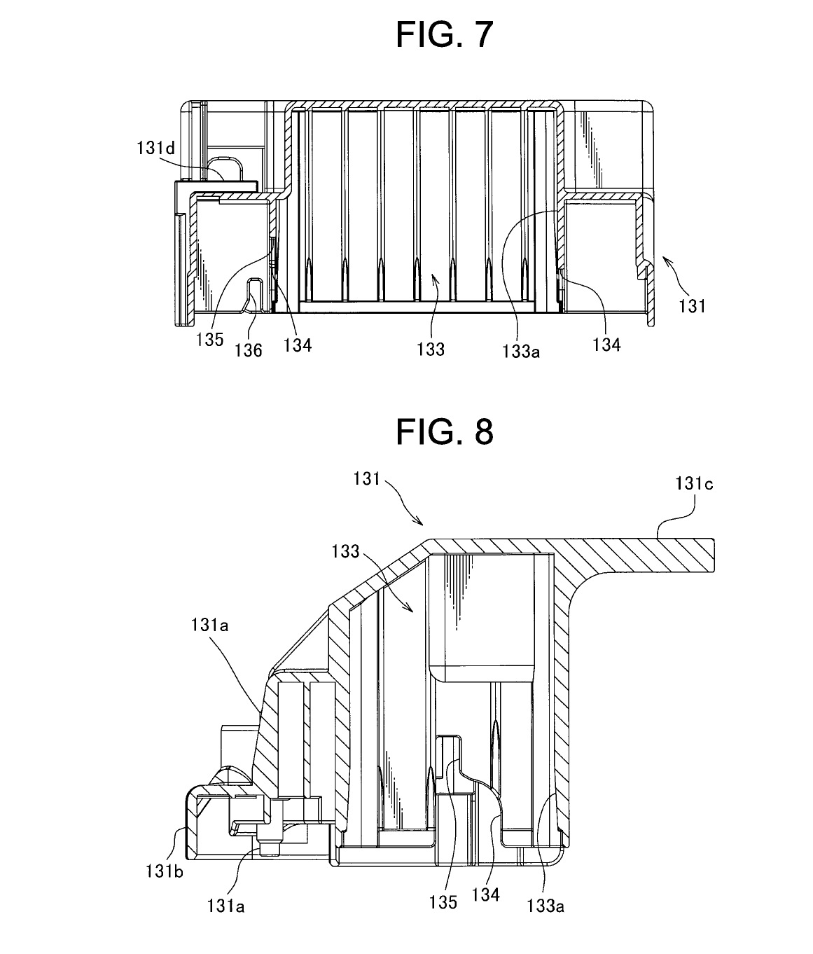

Hereinafter, the casing body 131 is described with reference to FIGS. 4 to 8. FIG. 4 is a view of the upper face of the casing body 131, FIG. 5 is a right side facial view of the casing body 131, FIG. 6 is a view of the bottom face of the casing body 131, FIG. 7 is a sectional view indicated by arrow A line in FIG. 6, and FIG. 8 is a sectional view indicated by arrow B line in FIG. 6.

The casing body 131 includes a lower periphery projection part 131b which is formed by the lower periphery located at the cover member 132 side and projecting forward. At each of the right and left end sides of the lower periphery projection part 131b, there is provided the external connection terminal 131a. The cover member 132 is affixed thereto with covering the lower face of the lower periphery projection part 131b. Further, the casing body 131 includes an upper periphery projection part 131c projecting in the rearward direction that is the opposite direction to the lower periphery projection part 131b. At the right and left end sides of the upper periphery projection part 131c, there are provided collar including penetration holes 137, 138 through which bolts for affixing the electrical junction box 1A to a predetermined attachment location are to pass. In this embodiment, among the two right and left penetration holes 137, 138, the penetration hole 138 which is shown in the upper area in FIGS. 4 and 6, is formed in an elongated-hole shape. A dimensional tolerance at the positions of the penetration holes 137, 138 is absorbed by this elongated-hole shape. Further, on the upper face of the casing body 131, there is provided a connector retaining portion 131d in which the control connector 114 shown in FIGS. 2 and 3 is fitted and is retained thereby.

The accommodation portion 133 provided in the casing body 13, is configured with the hole 133a which is provided at the casing body 131 and opens downwardly, and the cover portion 133b which closes the opening of the hole 133a as shown in FIGS. 6 to 8. The relay 11 is received within the hole 133a which corresponds to the accommodation portion 133, in a posture that the terminals 112 thereof are opposing to the cover portion 133b.

The lead-out portion 134 is a cylindrical cut-out portion provided at both of the side walls of the hole 133a. The electrical wire 12 in which the first end round terminal 127 is connected to the terminals 112 of the relay 11, is led out to the outside of the hole 133a through the lead-out portion 134. Further, in a rear face of the lower periphery projection part 131b, the rear face covered by the cover member 132, there is provided a pair of right and left routing grooves 131d which introduces each of the right and left electrical wires 12 to the external connection terminal 131a. The electrical wire 12 is firstly led out from the lead-out portion 134, and subsequently, the electrical wire 12 is introduced toward the external connection terminal 131a by passing through the inside of the routing groove 131d. At the location where the electrical wire 12 is introduced, a second end round terminal 128 is connected to the external connection terminal 131a. Electrical wires led out from the above-described batteries and not shown various electrical equipment are connected to the external connection terminal 131a.

Further, a first control lead-out portion 135 and a second control lead-out portion 136 are provided in a vicinity of the lead-out portion 134 shown in FIG. 8 among the right and left lead-out portions 134. The first control lead-out portion 135 is a member which takes out the control electrical wire 113 shown in FIGS. 2 and 3 from the hole 133a. The first control lead-out portion 135 is formed to be a cut-out portion which is deeper than the lead-out portion 134, the first control lead-out portion 135 being continued to the lead-out portion 134. The second control lead-out portion 136 is a member which takes out the control electrical wire 113 down to a route extending to the control connector 114 that is retained by the connector retaining portion 131d via the outside of the casing body 131. The second control lead-out portion 136 is formed to be a cut-out portion adjacent to the first control lead-out portion 135. The control electrical wire 113 is led out to the outside of the casing body 131 via the first control lead-out portion 135 and the second control lead-out portion 136, and the control connector 114 at the tip thereof is retained by the connector retaining portion 131d.

Here, as shown in FIGS. 2 and 3, the electrical junction box 1A is configured to include an inner mold 14 (first support member) in which the first supporter that supports the relay 11 is interposed between the relay 11 and the inner face of the accommodation portion 133. Further, the second supporter is configured to include a soft tape 15 (second support member) that is interposed between the electrical wire 12 and the lead-out portion 134. The second supporter supports the relay 11 via the electrical wire 12 and is wound by the electrical wire 12.

In this embodiment, the inner mold 14 is configured to include an innermost-side member 141 provided at the innermost-side of the hole 133a in the accommodation portion 133, and an opening-side member 142 provided at opening-side of the hole 133a and at the cover portion 133b side. Each of the members is made of urethane foam as elastic material and has a vibration-free property. In each of the members, there is provided a concave in which the relay 11 is fitted. As shown in FIG. 3, the relay 11 is clamped from up and down by these two members and is accommodated in the accommodation portion 133 in a state where the relay 11 is surrounded by the inner mold 14 with no gaps therebetween. Further, when the relay 11 is being accommodated, the inner mold 14 is in close contact with the inner face of the accommodation portion 133. Further, at the right and left side faces of the opening-side member 142 which serves as the inner mold 14, an insertion portion 143 into which the electrical wire 12 is inserted, is formed in a cylindrical cut-out portion-like shape.

The soft tape 15 is a resilient member and is wound around a vicinity of the first end of the electrical wire 12 that is connected to the terminals 112 of the relay 11. Then, the soft tape 15 is fitted into a space that is formed by the insertion portion 143 of the opening-side member 142 in the inner mold 14 and by the lead-out portion 134 in the casing body 13.

According to the electrical junction box 1A of this embodiment, the relay 11 are contactlessly supported with respect to the accommodation portion 133 by the two support members consisted of the inner mold 14 and the soft tape 15 that are elastic materials, each of which has vibration-free property. Further, the relay 11 is accommodated in the accommodation portion 133 in a manner surrounded by the accommodation portion 133. Thereby, even when noises or vibrations are generated at the relay 11, the noises or vibrations are prevented from being directly transmitted to the accommodation portion 133, that is, the casing body 13. Furthermore, since the two support members are made of elastic materials having vibration-free property, noises or vibrations transmitted to the inner face of the accommodation portion 133 from the relay 11 via the inner mold 14 are attenuated, and noises or vibrations transmitted to the lead-out portion 134 from the relay 11 via the electrical wire 12 or the soft tape 15 are attenuated. Thereby, noise insulating property and vibration-free property thereof can be further enhanced.

Further, according to the electrical junction box 1A of this embodiment, noises generated at the relay 11 can be prevented from leaking out by the inner mold 14 surrounding the relay 11 without creating any gaps therebetween, and by the inner mold 14 being provided with the inner face of the accommodation portion 133 in close contact thereto. Further, since the insertion portion 143 is formed in the inner mold 14 and the electrical wire 12 is led out through the insertion portion 143, noises and vibrations leaked out by their propagation on the electrical wire 12 can also be suppressed.

Further, according to the electrical junction box 1A of this embodiment, noises generated at the relay 11 and propagating via the electrical wire 12 can be prevented from leaking out to the outside of the accommodation portion 133 by letting the soft tape 15 surround the relay 11 without creating any gaps therebetween and by providing the soft tape 15 with the inner periphery of the lead-out portion 134 in close contact thereto.

Further, according to the electrical junction box 1A of this embodiment, the accommodation portion 133 is composed of the hole 133a of the casing body 131 and the cover portion 133b, and the inner mold 14 is configured to include the innermost-side member 141 and the opening-side member 142. That is, the inner mold 14 is at least divided into two pieces by the innermost-side and the opening-side of the hole 133a. Thereby, the assembly procedures when accommodating the relay 11 and the inner mold 14 in the accommodation portion 133 can be optimized. Specifically, the innermost-side member 142 is firstly set in the hole 133a of the casing body 131 as shown in FIGS. 9 and 10. Subsequently, the relay 11 is fitted in the innermost-side member 142 and is supported therein. Next, the opening-side member 142 is set in the hole 133a in a state where the opening-side member 142 is in close contact with the innermost-side member 142 and the relay 11. Subsequently, the hole 133a is closed by the cover portion 133b (refer to FIG. 2), thereby, the relay 11 and the inner mold 14 can be securely and easily assembled to the accommodation portion 133.

### Second Embodiment

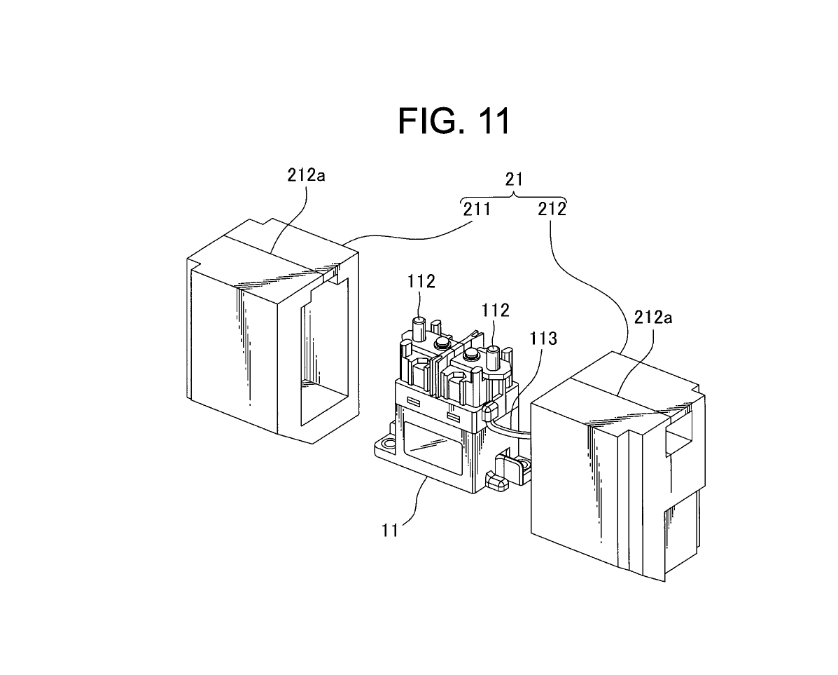

Next, the electrical junction box according to a second embodiment of the present invention is described with reference to FIG. 11. Incidentally, the electrical junction box according to this second embodiment is equivalent to the electrical junction box 1A of the first embodiment except for the inner mold as the first support member which supports the relay 11. Hereinafter, the electrical junction box according to the second embodiment is described focusing on the inner mold which is a difference from the electrical junction box 1A of the first embodiment. Further, as for the components shown in FIG. 11 that are the equivalent to the components of the electrical junction box 1A shown in FIGS. 1 to 10 in accordance with the first embodiment, the same reference numbers as those are assigned to the components shown in FIG. 11. Hence, the duplicate descriptions of the same components will be omitted hereinafter.

In the electrical junction box according to the second embodiment, as shown in FIG. 11, an inner mold 21 is configured to include a first member 211 and a second member 212 which clamp the relay 11 from the right and left sides thereof. Also in this embodiment, each of these members is made of urethane foam as elastic material and possesses vibration-free property. Each member is provided with a concave in which the relay 11 is set, and the relay 11 is clamped from the right and left sides thereof and is accommodated in the accommodation portion 133 (refer to FIG. 2) in a state surrounded by the inner mold 21 without creating any gaps therebetween. In this embodiment, the electrical junction box is assembled in the procedure in which the relay 11 is firstly clamped from the right and left sides thereof by the first member 211 and the second member 212, subsequently, the clamped stuff is set in the hole 133a of the accommodation portion 133, and in final, the hole 133a is covered by the cover portion 133b.

Further, in each of the first member 211 and the second member 212, the control electrical wire 113 extending to the control connector 114 and slits 211a, 212a through which the electrical wire 12 (refer to FIG. 2) connected to the terminals 112 are passed, is provided on an opposing surface opposed to the cover portion 133b, the opposing surface facing upward when the above-described assembly procedures are implemented. When assembling, the control electrical wire 113 and the electrical wire 12 can be easily routed by pushing them toward the slits 211a, 212a from upward. Further, since the control electrical wire 113 is supported in a state being sandwiched between the slits 211a, 212a, the generation of gaps at a passing part of the control electrical wire 113 is suppressed, and noises generated at the passing part and leaking out therefrom are also suppressed.

In the electrical junction box according to the above-described second embodiment, vibrations generated at the relay 11 are absorbed by the inner mold 21 and the soft tape 15 (refer to FIG. 2), and the propagations of the vibrations toward the casing body 13 are suppressed. Thereby, strange noises caused by the vibrations generated at the relay 11 are suppressed.

The above-described embodiments are to merely show representative exemplifications of the present invention, the present invention is not limited to these embodiments. That is, the present invention can be implemented by various modifications without departing from the gist thereof.

For example, although in each of the embodiments, the electrical wire 12 has been exemplified as an electrical connection member which connects the terminals 112 and the external connection terminal 131a, the electrical connection member is not limited to an electrical wire, the electrical connection member may also be a bus bar, for example.

Further although in each of the embodiments, an aspect in which the relay 11 is supported by the two supporters consisted of the first supporter having the inner mold 21 and the second supporter having the soft tape 15 is exemplified, the supporter which supports the relay 11 may be solely consisted of the one of the supporter. Further, as for the support consisted of the second supporter solely, the resilient member such as the soft tape 15 may not be provided, and the electrical wire 12 may be affixed at a vicinity of the lead-out portion 134. In this case, the relay 11 may be supported solely by elasticity of the electrical wire 12 with respect to the casing body 13 in a contactless manner.

Further, although in each of the embodiments, the inner mold 14 made of urethane foam is exemplified as the first support member interposed between the relay 11 and the inner face of the accommodation portion 133, the first support member is not limited to be made of urethane foam. The first support member may be made of rubber or resin, or may be made by blowing polyurethane onto the relay 11, or may be made of/by the like.

Further, although in each of the embodiments, the electrical junction boxes 1A, 1B accommodating one relay have been exemplified for the electrical junction box, the electrical junction box may be the one which accommodates multiple relays, or may be the one which accommodates more than one relay, a fuse, and an electrical circuit substrate or the like. The electrical junction box may be the one which accommodates electrical components other than the relay.

### REFERENCE SIGNS LIST

1A electrical junction box
11 relay
12 electrical wire
13 casing body
14, 21 inner mold
15 soft tape
112 terminal
131 casing body
131a external connection terminal
133 accommodation portion
133a hole
133b cover portion
134 lead-out portion
141 innermost-side member
142 opening-side member
211 first member
212 second member

1. An electrical junction box comprising:
an electrical component equipped with a terminal;
an electrical connection member connected to the terminal of the electrical component;
a casing body made of insulation resin and accommodating the electrical components; and
at least one of a first supporter supporting the electrical component by a first support member interposed between the electrical component and an inner face of an accommodation portion, and a second supporter supporting the electrical component via the electrical connection member, wherein
the casing body is formed to include the accommodation portion which contactlessly accommodates the electrical component in a manner surrounding the electrical component, and a lead-out portion leading the electrical connection member out from the accommodation portion.

2. The electrical junction box according to claim 1, wherein
the first support member is made of elastic material having vibration-free property and surrounds the electrical component with no gaps therebetween, and the electrical junction box is provided in close contact with the inner face of the accommodation portion, and wherein
the first support member is provided with an insertion portion having the electrical connection member insert thereinto.

3. The electrical junction box according to claim 1, wherein
the second supporter is formed to include a second support member made of elastic material having vibration-free property, the second support member interposed between the electrical connection member and the lead-out portion, and wherein
the second support member surrounds the electrical connection member with no gaps therebetween and is provided in close contact with an inner periphery of the lead-out portion.

4. The electrical junction box according to claim 2, wherein
the second supporter is formed to include a second support member made of elastic material having vibration-free property, the second support member interposed between the electrical connection member and the lead-out portion, and wherein
the second support member surrounds the electrical connection member with no gaps therebetween and is provided in close contact with an inner periphery of the lead-out portion.

5. The electrical junction box according to claim 1, wherein
the accommodation portion is composed of a hole having an opening that opens toward one side, and a cover portion for covering the opening of the hole, and wherein
the first support member is configured to include an innermost-side member provided at an innermost-side of the hole and an opening-side member provided at the opening-side of the hole as well as at the cover portion side.

6. The electrical junction box according to claim 2, wherein
the accommodation portion is composed of a hole having an opening that opens toward one side, and a cover portion for covering the opening of the hole, and wherein
the first support member is configured to include an innermost-side member provided at an innermost-side of the hole and an opening-side member provided at the opening-side of the hole as well as at the cover portion side.

7. The electrical junction box according to claim 3, wherein
the accommodation portion is composed of a hole having an opening that opens toward one side, and a cover portion for covering the opening of the hole, and wherein
the first support member is configured to include an innermost-side member provided at an innermost-side of the hole and an opening-side member provided at the opening-side of the hole as well as at the cover portion side.

8. The electrical junction box according to claim 4, wherein
the accommodation portion is composed of a hole having an opening that opens toward one side, and a cover portion for covering the opening of the hole, and wherein
the first support member is configured to include an innermost-side member provided at an innermost-side of the hole and an opening-side member provided at the opening-side of the hole as well as at the cover portion side.
